(19) United States
(12) Patent Application Publication
(10) Pub. No.: US 2024/0022037 A1
(43) Pub. Date: Jan. 18, 2024

(54) APPARATUS FOR BANDING AND PEELING CONNECTOR RIBBON

(71) Applicant: HANWHA SOLUTIONS CORPORATION, Seoul (KR)

(72) Inventors: Kwang Young SONG, Eumseong-gun (KR); Keun Hwan KWON, Daegu (KR); Sang Ho KIM, Jincheon-gun (KR)

(21) Appl. No.: 18/254,889

(22) PCT Filed: Nov. 17, 2021
(86) PCT No.: PCT/KR2021/016869

§ 371 Date: May 30, 2023

(30) Foreign Application Priority Data
Nov. 30, 2020 (KR) 10-2020-0163718

(51) Int. Cl. H01R 43/28; B26D 7/18; B26D 3/28

(52) U.S. Cl. CPC H01R 43/28; B26D 7/1863; B26D 3/282

(57) ABSTRACT

The present disclosure may provide an apparatus for bending and peeling a connector ribbon on which a protective film is laminated, the apparatus including a clamp configured to fix a second area of the connector ribbon excluding a first area thereof, a peeling cutter disposed at one side of the first area, and a driver configured to move the peeling cutter, wherein the peeling cutter moves to come in contact with the first area and, while pushing and bending the first area, peels the protective film of at least a portion of the first area.

### TECHNICAL FIELD

The present disclosure relates to an apparatus for bending and peeling a connector ribbon applied to a solar battery module.

### BACKGROUND ART

Generally, a solar battery module is made of a form in which a front glass plate, an encapsulation material (e.g., an ethylene vinyl acetate (EVA) resin, etc.), a solar battery cell, an encapsulation material, and a resin-based back sheet are bonded, and power generation occurs at one side of the module. Meanwhile, a glass-to-glass type solar battery module has improved durability and allows both sides of the solar battery module to contribute to power generation. The glass-to-glass type solar battery module is made of a form in which a first glass plate, an encapsulation material, a solar battery cell, an encapsulation material, and a second glass plate are bonded.

A junction box is disposed on one surface of a back sheet of a solar battery module. The junction box is a device for delivering pre-production power from the solar battery module to the outside. The solar battery module may include a plurality of solar battery cells, and the solar battery cells may be electrically connected through connector ribbons. Some of the connector ribbons are connected to the junction box through the back sheet. Ends of such connector ribbons are bent by almost 90% and connected to the junction box. Also, the bent ends of the connector ribbons are connected to the junction box in a state in which a protective film is removed from the bent ends. Conventionally, the protective film of the bent ends of the connector ribbons is manually peeled using a separate tool (e.g., a knife). However, the task of manually peeling the protective film of the ends of the connector ribbons takes a long time, is repetitive, and is very cumbersome. Also, due to an adhesive for adhering the protective film to an alloy layer, it is very difficult to peel the protective film after laminating, and the peeled protective film sticks to the ends of the connector ribbons and interferes with welding the ends of the connector ribbons to the junction box, thus significantly reducing productivity and quality.

### DISCLOSURE

### Technical Problem

The present disclosure is directed to providing an apparatus for bending and peeling a connector ribbon that can automatically bend an end of a connector ribbon and, simultaneously, peel a protective film thereof.

Objectives to be achieved by the present disclosure are not limited to the above-mentioned objective, and other objectives unmentioned herein should be clearly understood by those of ordinary skill in the art from the description below.

### Technical Solution

One embodiment provides an apparatus for bending and peeling a connector ribbon on which a protective film is laminated, the apparatus including a clamp configured to fix a second area of the connector ribbon excluding a first area thereof, a peeling cutter disposed at one side of the first area, and a driver configured to move the peeling cutter, wherein the peeling cutter moves to come in contact with the first area and, while pushing and bending the first area, peels the protective film of at least a portion of the first area.

The first area may be disposed in a horizontal direction, the driver may move the peeling cutter in an up-down direction, and the peeling cutter may be disposed to be tilted relative to the first area.

The peeling cutter may include a body connected to the driver and a cutter blade configured to extend from the body, the cutter blade may include a first surface and a second surface configured to form an edge of the cutter blade, and the first surface and the second surface may be disposed in a direction inclined relative to the horizontal direction.

The edge of the cutter blade may be disposed to be spaced apart from the body in the horizontal direction.

The peeling cutter may include a plurality of ribs configured to protrude from the first surface.

The apparatus may further include a brush connected to the driver and configured to move in a left-right direction, and by being disposed so that the cutter blade is positioned on a movement path of the brush, the brush may clean the cutter blade.

The brush may be mounted on a first stage of the driver on which the peeling cutter is mounted and may move along with the peeling cutter in a front-rear direction.

The apparatus may further include a suction unit to which a suction tube is connected, and the suction tube may be disposed adjacent to the cutter blade to allow the suction unit to suction the protective film peeled from the first area.

The suction tube may be mounted on the first stage of the driver on which the peeling cutter is mounted and may move along with the suction tube in a front-rear direction.

The apparatus may further include a vision device disposed behind the clamp to obtain an image of a peeled area of the first area from which the protective film is removed.

The clamp may be connected to the driver and move vertically, the apparatus may further include a groove configured to accommodate the connector ribbon and a base connected to the groove and including a seating portion on which the clamp is seated, and the clamp may fix the connector ribbon in a state in which the clamp is seated on the seating portion.

The clamp may be mounted on the first stage of the driver on which the peeling cutter is mounted and may move along with the peeling cutter in a front-rear direction.

The apparatus may further include a base on which the connector ribbon is placed, a first unit and a second unit each including the clamp, the peeling cutter, and the driver may be provided, the first area may include a first-first area disposed on one side of the base and a first-second area disposed on the other side of the base, the first unit may be disposed at the one side of the base to push and bend the first-first area and, simultaneously, peel a protective film of at least a portion of the first-first area, and the second unit may be disposed at the other side of the base to push and bend the first-second area and, simultaneously, peel a protective film of at least a portion of the first-second area.

### Advantageous Effects

According to an embodiment, by automatically bending an end of a connector ribbon that is connected to a junction box and, simultaneously, peeling a protective film, there are advantages that the quality is secured and productivity is enhanced.

According to an embodiment, there is an advantage that the number of workers can be significantly reduced.

According to an embodiment, there is an advantage that a protective film of a bent end of a connector ribbon can be uniformly peeled.

### DESCRIPTION OF DRAWINGS

FIG. 1 is a view illustrating a connector ribbon mounted on a base of an apparatus for bending and peeling a connector ribbon according to an embodiment.

FIG. 2 is a view illustrating a first unit and a second unit of the apparatus for bending and peeling a connector ribbon according to the embodiment, each of which is disposed at one of both sides of the base illustrated in FIG. 1.

FIG. 3 is a perspective view of the apparatus for bending and peeling a connector ribbon according to the embodiment.

FIG. 4 is an enlarged view of a peeling cutter illustrated in FIG. 3.

FIG. 5 is a perspective view illustrating the peeling cutter.

FIG. 6 is a lateral view of the peeling cutter illustrated in FIG. 5.

FIG. 7 is a view illustrating the peeling cutter coming in contact with the connector ribbon.

FIG. 8 is a view illustrating a state before the peeling cutter is aligned with a first area of the connector ribbon in a process of bending and peeling the connector ribbon.

FIG. 9 is a view illustrating a state in which the peeling cutter is aligned with the first area of the connector ribbon in the process of bending and peeling the connector ribbon.

FIG. 10 is a view illustrating a process in which a clamp moves downward and fixes the connector ribbon.

FIG. 11 is a view illustrating a state in which the peeling cutter moves upward to simultaneously bend the first area of the connector ribbon and peel a protective film thereof.

FIG. 12 is a view illustrating a process in which the peeling cutter is cleaned with a brush.

FIG. 13 is a view illustrating movement of the clamp and the peeling cutter after bending and peeling the connector ribbon is completed.

FIG. 14 is a view illustrating movement of the clamp and the peeling cutter after bending and peeling the connector ribbon is completed.

FIG. 15 is a view illustrating movement of the clamp and the peeling cutter after image capturing by a vision device is completed.

### NODES OF THE INVENTION

Objectives, specific advantages, and novel features of the present disclosure will become more apparent from the following detailed description and exemplary embodiments associated with the accompanying drawings. Also, terms or words used in the specification and the claims should not be interpreted as being limited to their general or dictionary meanings and should be interpreted to have meanings and concepts consistent with the technical spirit of the present disclosure, based on the principle that the inventor may appropriately define the concepts of terms in order to describe his or her invention in the best possible way. Also, in describing the present disclosure, detailed description of known related art that may unnecessarily obscure the gist of the present disclosure will be omitted.

Also, in describing elements of embodiments of the present disclosure, terms such as first, second, A, B, (a), and (b) may be used. Such terms are only for distinguishing one element from another element, and the essence, sequence, order, or the like of the corresponding element is not limited by the terms.

Hereinafter, in describing an apparatus for bending and peeling a connector ribbon according to an embodiment, in a case in which one element is described as being formed or disposed “on or under” another element, the “on or under” includes not only a case in which the two elements come in direct contact with each other but also a case in which one or more other elements are formed or disposed between the two elements. Also, the “on or under” may indicate a downward direction as well as an upward direction relative to one element.

Also, terms such as first and second may be used, but such terms are only for distinguishing one element from another element, and the essence, sequence, order, or the like of the corresponding element is not limited by the terms.

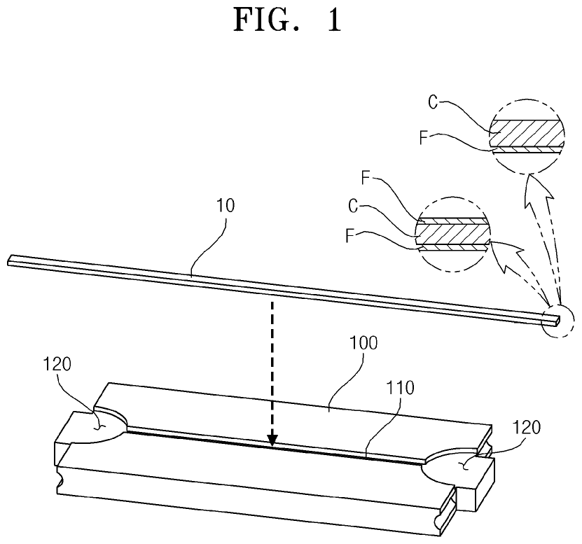

FIG. 1 is a view illustrating a connector ribbon mounted on a base of an apparatus for bending and peeling a connector ribbon according to an embodiment.

Referring to FIG. 1, a connector ribbon 10 is a belt-type member and may be cut to a predetermined length and seated on a base 100. The base 100 may include a groove 110 configured to accommodate the connector ribbon 10. Also, the base 100 may include a seating portion 120. The seating portion 120 may be disposed at each of one side and the other side of the groove 110. The seating portion 120 is disposed to be concave in an upper surface of the base 100. Also, the seating portion 120 may be disposed at each of both sides of the base 100. The seating portion 120 may communicate with the groove 110 and allow the connector ribbon to be accommodated.

The connector ribbon 10 placed on the base 100 has a protective film F (e.g., a polyimide film) disposed on a surface of a conductor C. The protective film F may be disposed on only one surface of the conductor C or disposed on both surfaces of the conductor C.

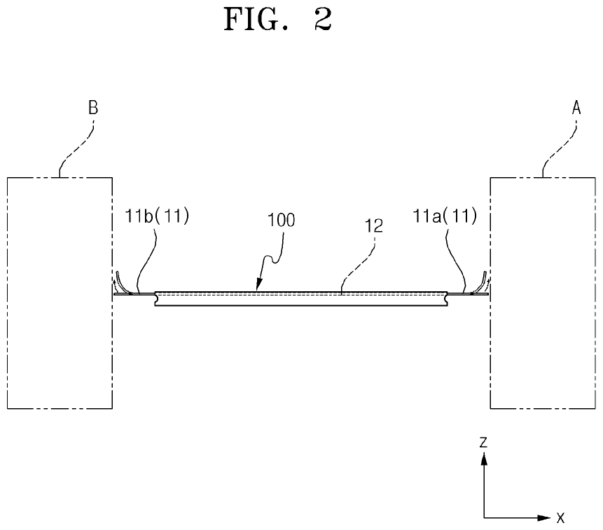

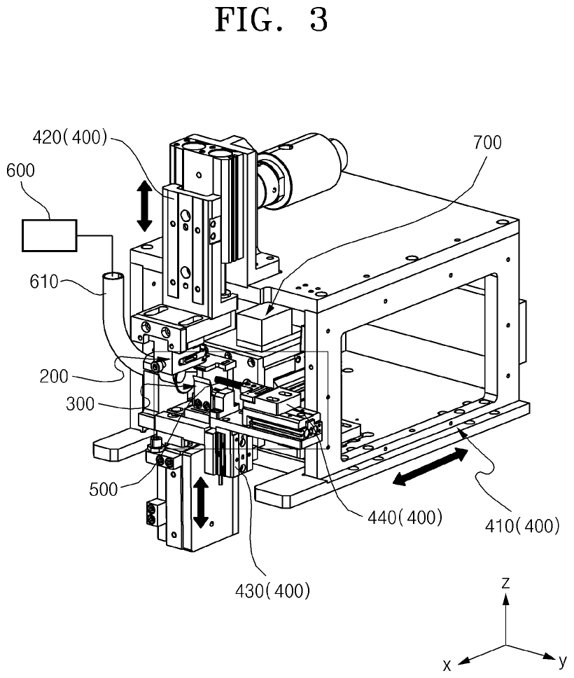

FIG. 2 is a view illustrating a first unit A and a second unit B of the apparatus for bending and peeling a connector ribbon according to the embodiment, each of which is disposed at one of both sides of the base 100 illustrated in FIG. 1, and FIG. 3 is a perspective view of the apparatus for bending and peeling a connector ribbon according to the embodiment.

Hereinafter, in the drawings, the x-axis indicates a front-rear direction of the apparatus for bending and peeling a connector ribbon, the y-axis indicates a left-right direction of the apparatus for bending and peeling a connector ribbon, and the z-axis indicates an up-down direction of the apparatus for bending and peeling a connector ribbon.

The base 100 is horizontally disposed, and in the front-rear direction, the first unit A may be disposed at one side of the base 100, and the second unit B may be disposed at the other side of the base 100. Each of the first unit A and the second unit B is a device that includes a clamp 200, a peeling cutter 300, and a driver 400 to bend both ends of the connector ribbon 10 and peel the protective film F. Due to the first unit A and the second unit B, both ends of the connector ribbon 10 may be bent and, simultaneously, the protective film F may be peeled.

Hereinafter, a partial area of the connector ribbon 10 that protrudes from the base 100 without being fixed to the clamp 200 and the base 100 will be referred to as a first area 11, and a partial area of the connector ribbon 10 that is fixed by the clamp 200 and the base 100 will be referred to as a second area 12. The first area 11 may be horizontally disposed.

As illustrated in FIG. 2, the first area 11 of the connector ribbon 10 is disposed to protrude from the base 100. The connector ribbon 10 may include, in the first area 11, a first-first area 11a protruding from one side of the base 100. The protective film F of the first-first area 11a is peeled simultaneously as the first-first area 11a is bent upward by the first unit A. Also, the connector ribbon 10 may include, in the first area 11, a first-second area 11b protruding from the other side of the base 100. The protective film F of the first-second area 11b is peeled simultaneously as the first-second area 11b is bent upward by the second unit B.

The clamp 200 serves to move vertically to fix the connector ribbon 10 to the base 100. The clamp 200 may enter the seating portion 120 of the base 100 and press and fix the second area 12 of the connector ribbon 10.

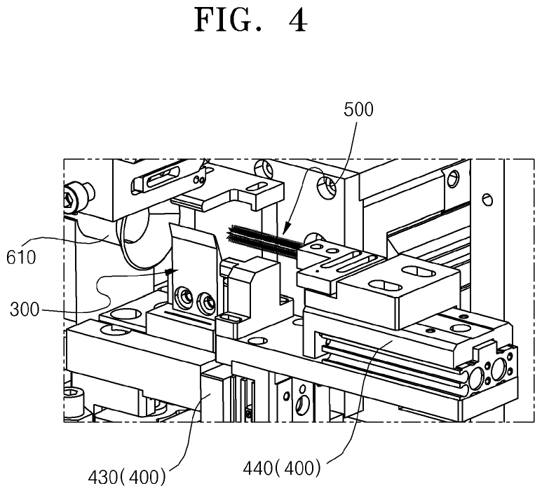

FIG. 4 is an enlarged view of the peeling cutter 300 illustrated in FIG. 3.

Referring to FIGS. 3 and 4, the peeling cutter 300 may be disposed under the first area 11 of the connector ribbon 10. The peeling cutter 300 serves to simultaneously bend the first area 11 and peel the protective film F of the first area 11. The peeling cutter 300 moves in the up-down direction. The first area 11 may be disposed on a movement path of the peeling cutter 300.

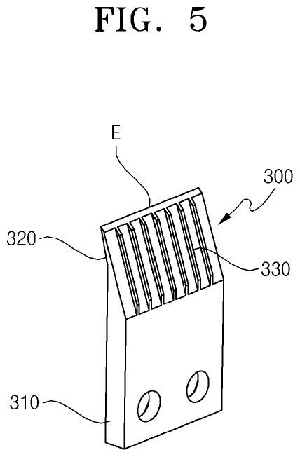

In the left-right direction (indicated by the y-axis), a brush 500 may be disposed on the right side in the drawings. The brush 500 moves in the left-right direction (indicated by the y-axis) and serves to, after the protective film F is peeled, clean and remove a residue of the protective film F left on the peeling cutter 300. A cutter blade 320 (see FIG. 5) of the peeling cutter 300 may be disposed to be positioned on a movement path of the brush 500.

In the left-right direction (indicated by the y-axis), a suction tube 610 may be disposed on the left side in the drawings. The suction tube 610 is connected to a suction unit 600 and serves to, when the protective film F is being peeled, absorb and remove the peeled protective film F. In a case in which the peeled protective film F sticks to the first area 11 again, the peeled protective film F may interfere with welding to a junction box. When the protective film F is being peeled by the peeling cutter 300, the suction tube 610 immediately absorbs the peeled protective film F, thus fundamentally preventing the peeled protective film F from interfering with welding to the junction box.

The suction unit 600 may operate when the peeling cutter 300 starts to bend the first area 11 and peel the protective film F and may stop operating when the task of bending and peeling the first area 11 is finished.

The driver 400 may include a first stage 410, a second stage 420, a third stage 430, and a fourth stage 440. The first stage 410, the second stage 420, the third stage 430, and the fourth stage 440 may be driven by a motor and a power transmission device configured to transmit a driving force of the motor.

The first stage 410 reciprocates in the front-rear direction. The clamp 200, the peeling cutter 300, the brush 500, and the suction tube 610 may be mounted on the first stage 410. Accordingly, when the first stage 410 moves in the front-rear direction (indicated by the x-axis), the clamp 200, the peeling cutter 300, the brush 500, and the suction tube 610 move together.

The second stage 420 is mounted on the first stage 410 and reciprocates in the up-down direction (indicated by the z-axis). The clamp 200 may be mounted on the second stage 420.

The third stage 430 is mounted on the first stage 410 and reciprocates in the up-down direction (indicated by the z-axis). The peeling cutter 300 may be mounted on the third stage 430.

The fourth stage 440 is mounted on the first stage 410 and reciprocates in the left-right direction (indicated by the y-axis). The brush 500 may be mounted on the fourth stage 440.

Meanwhile, a vision device 700 may be disposed at the first stage 410. The vision device 700 is a device for, after the first area 11 of the connector ribbon 10 is bent and peeled, obtaining image information of the first area 11. The vision device 700 may be disposed behind the peeling cutter 300.

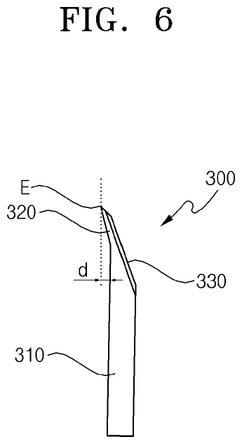

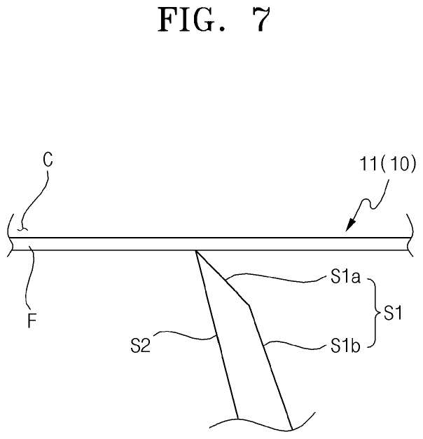

FIG. 5 is a perspective view illustrating the peeling cutter 300, FIG. 6 is a lateral view of the peeling cutter 300 illustrated in FIG. 5, and FIG. 7 is a view illustrating the peeling cutter 300 coming in contact with the connector ribbon 10.

Referring to FIGS. 5 to 7, the peeling cutter 300 may include a body 310 and the cutter blade 320 extending from the body 310. The body 310 may be coupled to the third stage 430. The cutter blade 320 serves to come in contact with the protective film F of the first area 11 of the connector ribbon 10 and simultaneously bend the first area 11 and peel the protective film F of the first area 11.

The cutter blade 320 may include a first surface S1 and a second surface S2 configured to form an edge E of the cutter blade 320. The first surface S1 and the second surface S2 may be inclined surfaces disposed to be inclined in the horizontal direction. The edge E of the cutter blade 320 may be disposed to be spaced apart from the body 310 in the horizontal direction. In the front-rear direction (indicated by the x-axis), the position of the edge E of the cutter blade 320 may be disposed to be spaced a predetermined distance d apart from a tip of the base 100.

Meanwhile, the first surface S1 may include a first-first surface S1a forming the edge E of the cutter blade 320 and a first-second surface S1b connected to the first-first surface S1a and the body 310. The cutter blade 320 may include a plurality of ribs 330 disposed to protrude from the first-second surface S1b. The ribs 330 serve to increase strength of the cutter blade 320.

The process of bending and peeling the connector ribbon 10 using the peeling cutter 300 is as follows.

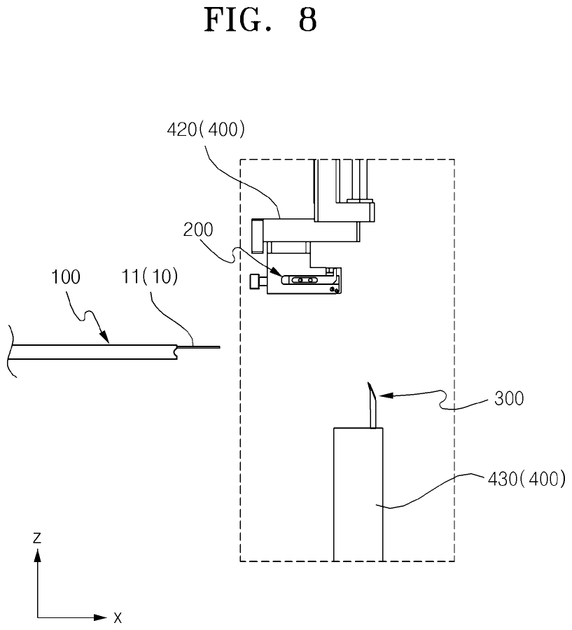

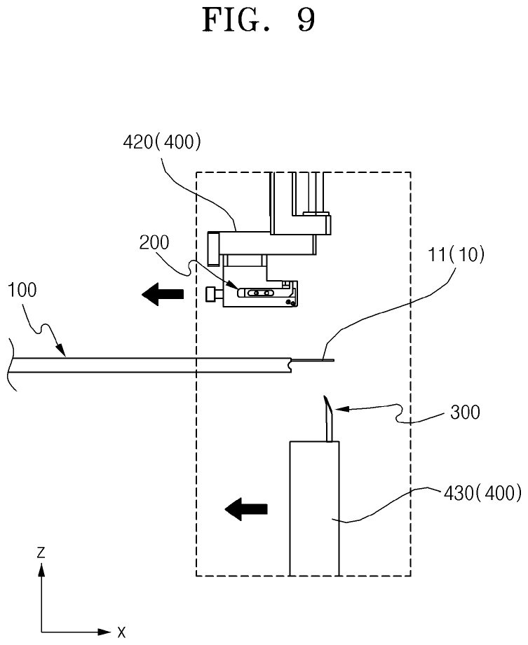

FIG. 8 is a view illustrating a state before the peeling cutter 300 is aligned with the first area 11 of the connector ribbon 10 in the process of bending and peeling the connector ribbon 10, and FIG. 9 is a view illustrating a state in which the peeling cutter 300 is aligned with the first area 11 of the connector ribbon 10 in the process of bending and peeling the connector ribbon 10.

Referring to FIGS. 8 and 9, the first stage 410 moves forward toward the base 100, and the peeling cutter 300 is aligned to be positioned under the first area 11 of the connector ribbon 10. When the first stage 410 moves forward, the clamp 200, the brush 500, and the suction tube 610 also move forward together.

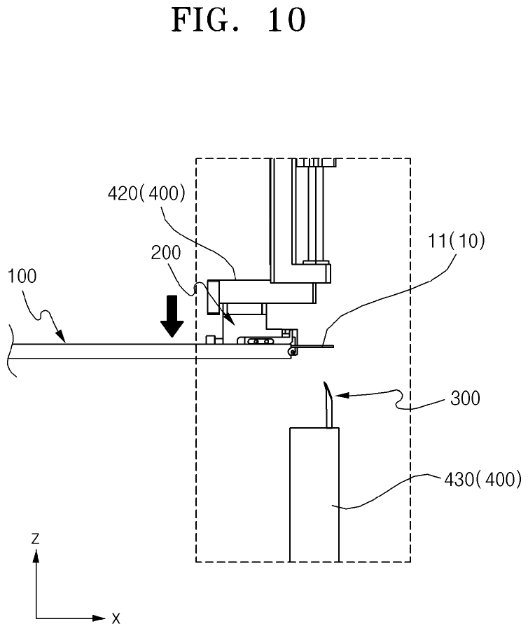

FIG. 10 is a view illustrating a process in which the clamp 200 moves downward and fixes the connector ribbon 10.

Referring to FIG. 10, in the state in which the peeling cutter 300 is aligned to be positioned under the first area 11 of the connector ribbon 10, the clamp 200 moves downward and is seated on the seating portion 120 (see FIG. 1) of the base 100. The clamp 200 seated on the seating portion 120 presses and fixes the second area 12 of the connector ribbon 10.

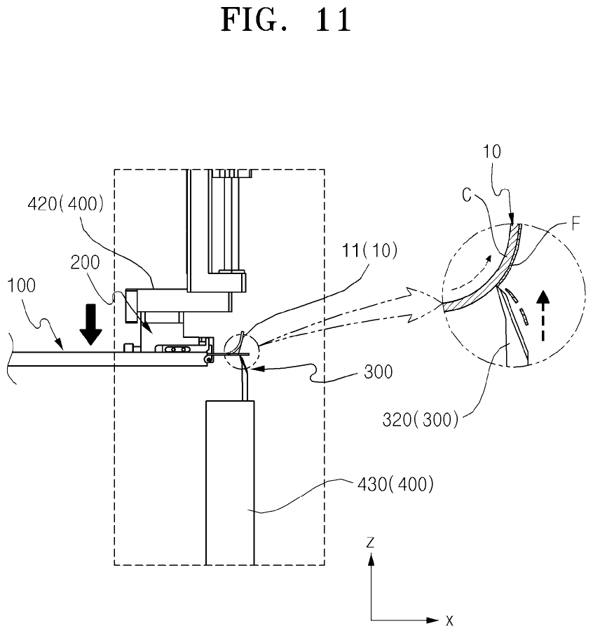

FIG. 11 is a view illustrating a state in which the peeling cutter 300 moves upward to simultaneously bend the first area 11 of the connector ribbon 10 and peel the protective film F thereof.

Referring to FIG. 11, in the state in which the first area 11 of the connector ribbon 10 is fixed by the clamp 200, the peeling cutter 300 moves upward and comes in contact with the first area 11. While in contact with the first area 11, the peeling cutter 300 moves upward to push and bend the first area 11. Simultaneously, the peeling cutter 300 peels the protective film F of the first area 11.

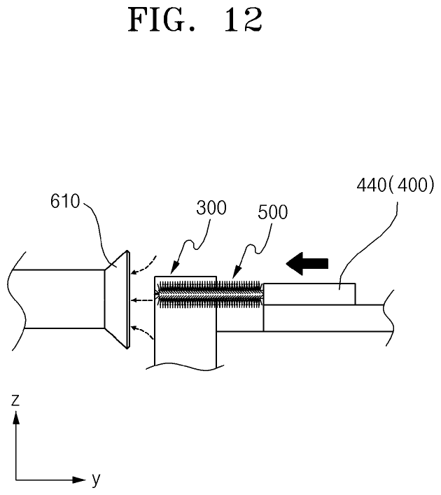

FIG. 12 is a view illustrating a process in which the peeling cutter 300 is cleaned with the brush 500.

Referring to FIG. 12, when bending and peeling the first area 11 is completed after the peeling cutter 300 moves upward to a predetermined height, the brush 500 moves toward the peeling cutter 300 in the left-right direction (indicated by the y-axis) and removes the protective film F left on the peeling cutter 300 and the peeled first area 11. Here, as the suction unit 600 operates, pieces of the protective film F falling from the peeling cutter 300 or the peeled first area 11 due to the brush 500 may be suctioned and removed by the suction tube 610.

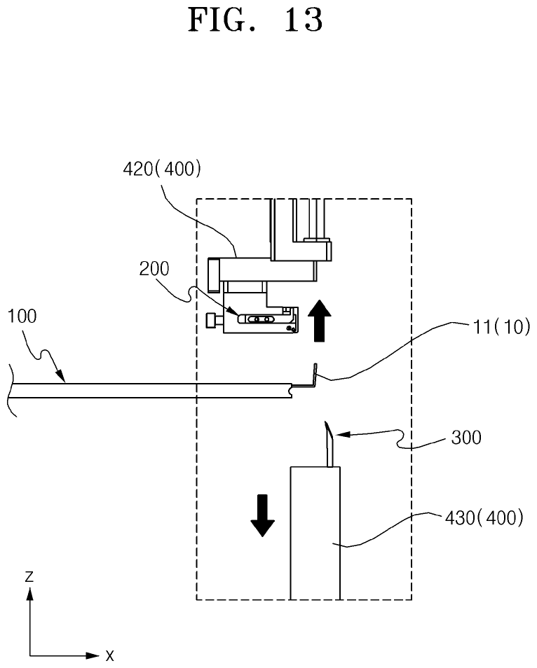

FIG. 13 is a view illustrating movement of the clamp 200 and the peeling cutter 300 after bending and peeling the connector ribbon 10 is completed.

Referring to FIG. 13, when the process of bending and peeling the first area 11 of the connector ribbon 10 is completed, the clamp 200 moves upward and unfixes the connector ribbon 10. Simultaneously, the peeling cutter 300 moves downward and is detached from the connector ribbon 10.

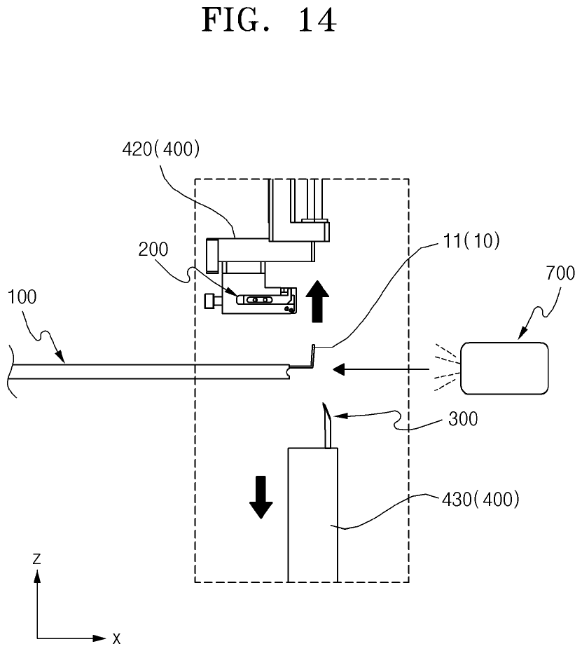

FIG. 14 is a view illustrating movement of the clamp 200 and the peeling cutter 300 after bending and peeling the connector ribbon 10 is completed.

Referring to FIG. 14, after the clamp 200 moves upward and the peeling cutter 300 moves downward, the vision device 700 captures an image of the peeled first area 11 to obtain image information. Based on the obtained image information, the vision device 700 may determine whether the first area 11 has been properly peeled.

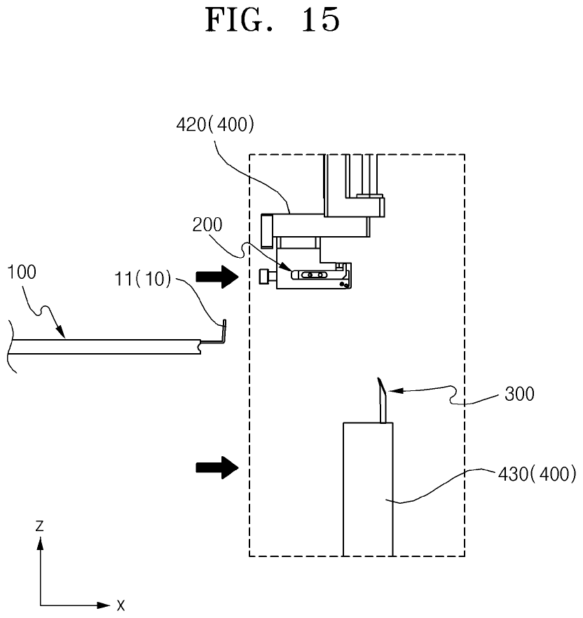

FIG. 15 is a view illustrating movement of the clamp 200 and the peeling cutter 300 after image capturing by the vision device 700 is completed.

Referring to FIG. 15, after image capturing by the vision device 700 is completed, the first stage 410 moves rearward, and the clamp 200 and the peeling cutter 300 are detached from the base 100 and return to their original positions. Then, the brush 600 may move toward the peeling cutter 300 again and clean the peeling cutter 300. The above-described bending and peeling task is repeated as the connector ribbon 10 for which bending and peeling have been completed is conveyed to a subsequent process through a separate conveying device, and a new connector ribbon 10 for which bending and peeling are necessary is placed on the base 100.

An apparatus for bending and peeling a connector ribbon according to one exemplary embodiment of the present disclosure has been described in detail above with reference to the accompanying drawings.

The above-described embodiment of the present disclosure should be understood as being illustrative, instead of limiting, in all aspects, and the scope of the present disclosure is defined by the claims below rather than by the detailed description given above. Also, the meaning and scope of the claims and all changes or modifications derived from their equivalents should be construed as falling within the scope of the present disclosure.

### Industrial Applicability

The present disclosure may be used in the field of manufacturing a solar battery module.

1. An apparatus for bending and peeling a connector ribbon on which a protective film is laminated, the apparatus comprising:
a clamp configured to fix a second area of the connector ribbon excluding a first area thereof;
a peeling cutter disposed at one side of the first area; and
a driver configured to move the peeling cutter,
wherein the peeling cutter moves to come in contact with the first area and, while pushing and bending the first area, peels the protective film of at least a portion of the first area.

2. The apparatus of claim 1, wherein the first area is disposed in a horizontal direction;
the driver moves the peeling cutter in an up-down direction; and
the peeling cutter is disposed to be tilted relative to the first area.

3. The apparatus of claim 2, wherein the peeling cutter includes a body connected to the driver and a cutter blade configured to extend from the body;
the cutter blade includes a first surface and a second surface configured to form an edge of the cutter blade; and
the first surface and the second surface are disposed in a direction inclined relative to the horizontal direction.

4. The apparatus of claim 3, wherein the edge of the cutter blade is disposed to be spaced apart from the body in the horizontal direction.

5. The apparatus of claim 4, wherein the peeling cutter includes a plurality of ribs configured to protrude from the first surface.

6. The apparatus of claim 3, further comprising a brush connected to the driver and configured to move in a left-right direction,
wherein, by being disposed so that the cutter blade is positioned on a movement path of the brush, the brush cleans the cutter blade.

7. The apparatus of claim 6, wherein the brush is mounted on a first stage of the driver on which the peeling cutter is mounted and moves along with the peeling cutter in a front-rear direction.

8. The apparatus of claim 1, further comprising a suction unit to which a suction tube is connected,
wherein the suction tube is disposed adjacent to the cutter blade to allow the suction unit to suction the protective film peeled from the first area.

9. The apparatus of claim 8, wherein the suction tube is mounted on the first stage of the driver on which the peeling cutter is mounted and moves along with the peeling cutter in a front-rear direction.

10. The apparatus of claim 1, further comprising a vision device disposed behind the clamp to obtain an image of a peeled area of the first area from which the protective film is removed.

11. The apparatus of claim 1, wherein the clamp is connected to the driver and moves vertically;
the apparatus further comprises a groove configured to accommodate the connector ribbon and a base connected to the groove and including a seating portion on which the clamp is seated;
and the clamp fixes the connector ribbon in a state in which the clamp is seated on the seating portion.

12. The apparatus of claim 11, wherein the clamp is mounted on the first stage of the driver on which the peeling cutter is mounted and moves along with the peeling cutter in a front-rear direction.

13. The apparatus of claim 1, further comprising a base on which the connector ribbon is placed,
wherein a first unit and a second unit each including the clamp, the peeling cutter, and the driver are provided;
the first area includes a first-first area disposed on one side of the base and a first-second area disposed on the other side of the base;
the first unit is disposed at the one side of the base to push and bend the first-first area and, simultaneously, peel a protective film of at least a portion of the first-first area; and
the second unit is disposed at the other side of the base to push and bend the first-second area and, simultaneously, peel a protective film of at least a portion of the first-second area.
